(19) United States
(12) Patent Application Publication
(10) Pub. No.: US 2025/0383305 A1
(43) Pub. Date: Dec. 18, 2025

(54) Multi-energy portal for x-ray inspection

(71) Applicant: LINEV Systems US, Inc., Conroe, TX (US)

(72) Inventors: Vladimir N. Linev, Minsk (BY); Dzmitryi Bairashewski, Minsk (BY)

(21) Appl. No.: 19/198,444

(22) Filed: May 5, 2025

Related U.S. Application Data
(60) Provisional application No. 63/658,941, filed on Jun. 12, 2024.

(51) Int. Cl. G01N 23/10; G01N 23/04; G01N 23/083

(52) U.S. Cl. CPC G01N 23/10; G01N 23/04; G01N 23/083; G01N 2223/3307; G01N 2223/401

(57) ABSTRACT

System for scanning an object, including first X-ray source emitting a first fan shaped beam; second X-ray source emitting second fan shaped beam; the first and second beams are parallel; first detector and second detector that detect X-rays passing through the object from the sources; wherein the first X-ray source and the second X-ray source focal spots are at a same height; the object moves laterally past the first beam and the second beam and parallel to a line connecting focal spots of first source and second source; first source has photon energy of E1 MeV and E2 MeV, such that beams are emitted in short pulses alternating between E1 and E2, wherein E1 and E2 are between 450 KeV and 9 MeV; and second source has photon energy of 70 KeV to 450 KeV; workstation combines atomic numbers and signal intensities generated by X-rays.

### FIELD OF THE INVENTION

The present invention relates to the design of X-ray inspection systems and to X-ray image processing methods that allow to enhance the quality of X-ray images obtained by such systems, namely by providing atomic number calculation for materials and by improving spatial resolution. Also in some cases, the invention relates to an inspection system that is significantly less expensive by using more economical components.

### DESCRIPTION OF THE RELATED ART

Today, there are numerous systems on the market that use a variety of X-ray-based mechanisms to inspect objects, such as suitcases, cargo, trucks, etc. Typically, the energy of the X-rays is selected based on the specific task at hand, and often these tasks are successfully solved. Nevertheless, there are a number of situations where a specific energy range of the X-rays that the system produces is insufficient. In such an event, the task is often subdivided into sub-tasks, and each such sub-task uses its own system with a particular X-ray energy range. This increases complexity, cost and inspection time.

Accordingly, there is a need in the art for a more universal system with multiple X-ray energy ranges, to address cases where a single X-ray energy range is insufficient.

### SUMMARY OF THE INVENTION

Accordingly, the present invention is related to a multi-energy portal for x-ray inspection that substantially obviates one or more of the disadvantages of the related art.

In one aspect, there is provided a system for scanning an object, including a first X-ray source emitting a first fan shaped X-ray beam; a second X-ray source emitting a second fan shaped X-ray beam; wherein the first and second fan shaped X-ray beams are parallel; a first detector and a second detector that detect X-rays passing through the object from the first and second X-Ray sources, respectively; wherein the first X-ray source and the second X-ray source focal spots are at a same height; wherein the object moves laterally past the first fan shaped X-ray beam and the second fan shaped X-ray beam and parallel to a line connecting focal spots of the first X-ray source and the second X-ray source; wherein the first X-ray source is a source with a photon energy of E1 MeV and E2 MeV, such that beams are emitted in short pulses alternating between E1 and E2, wherein E1 and E2 are between 450 KeV and 9 MeV; and wherein the second X-ray source is a source with a photon energy of E3, wherein E3 is between 70 KeV and 450 KeV; and a workstation that combines atomic numbers and signal intensities obtained from the detector generated by X-rays from the first and second X-ray sources passing through the cargo.

Optionally, the object is any of a suitcases, a cargo, or a truck. Optionally, the first and second detectors form an L-shape. Optionally, photons of first source penetrate thick objects that are not penetrable by second x-ray source photons. Optionally, photons of second source can penetrate only lower density objects that are too transparent for the photons of first X-Ray source. Optionally, E1 is between 6 MeV to 7.5 MeV. Optionally, E2 is between 3 MeV and 5 MeV. Optionally, E3 is between 200 KeV and 450 KeV. Optionally, the first and second X-ray sources are located on a side of a vehicle containing the object. Optionally, the system further comprises a third X-ray source emitting a third fan shaped X-ray beam; and a fourth X-ray source emitting a fourth fan shaped X-ray beam; optionally, the third and fourth X-ray sources are located on a top of a vehicle containing the object; wherein the third and fourth fan shaped X-ray beams are parallel to each other; a third detector and a fourth detector that detect X-rays passing through the object from the third and fourth X-Ray sources, respectively; Optionally, the third and fourth detectors form a U-shape. Optionally, the third X-ray source and the fourth X-ray source focal spots are at a same height and along the same horizontal line towards a motion axis of the object being scanned. Optionally, the third X-ray source is a source with a photon energy of E1 MeV and E2 MeV, such that beams are emitted in short pulses alternating between E1 and E2, wherein E1 and E2 are between 450 KeV and 9 MeV; and wherein the fourth X-ray source is a source with a photon energy of E3, wherein E3 is between 70 KeV and 450 KeV. Optionally, the object moves laterally past the first fan shaped X-ray beam and the second fan shaped X-ray beam and parallel to a line connecting focal spots of the first X-ray source and the second X-ray source. Optionally, the object moves laterally past the third fan shaped X-ray beam and the fourth fan shaped X-ray beam and parallel to a line connecting focal spots of the third X-ray source and the fourth X-ray source.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIGS. 1A, 1B illustrate one embodiment of the invention in a vehicle and cargo inspection system.

FIG. 2 shows, as an example, penetration deficiency for 320 keV source (above) and high penetration combined with material identification for the 7.5 MeV accelerator.

FIG. 3 illustrates multi-energy image fusion.

FIG. 4 shows how a multi-energy system keeps the highest image detail even on a thick background.

FIG. 5 shows samples of improved spatial resolution.

FIG. 6 shows a high-energy-only image.

FIG. 7 shows a combined multi-energy image.

FIGS. 8A, 8B show a positioning scheme of the sources points relative to the inspected object from the side and from the top.

FIG. 9 shows a sample intensity matrix.

FIG. 10 shows a sample atomic number matrix.

FIG. 11 thus illustrates, as an example, an overlay of projection images made in 320 kV (on the top) and in 7.5 MeV (on the bottom).

FIG. 12 shows another illustration of an exemplary system according to the invention.

### DETAILED DESCRIPTION OF EMBODIMENTS OF THE INVENTION

Reference will now be made in detail to the preferred embodiments of the present invention, examples of which are illustrated in the accompanying drawings.

The present disclosure proposes an X-ray inspection scanner-a system in which the object to be inspected passes through a fan-shaped X-ray beam, and the radiation that penetrates the object is registered by a linear X-ray receiver. Based on the received signals, a resulting X-ray projection image is generated, which contains the information on the shape, density, and composition of the object. The information on the composition of the object, specifically the atomic numbers of the materials it is made of, can be obtained based on different X-ray absorption properties at different energy levels, wherein some materials can be more easily distinguished at certain levels than the others.

One aspect of the invention is the use of two X-ray sources operating in two significantly different energy ranges, namely a high-energy source and a low-energy source, to obtain two X-ray projections of the same inspected object which are subsequently combined into a single image with enhanced quality, including atomic number calculation for materials and improved spatial resolution.

Another aspect of the invention is a way to mutual position the object to be inspected and the two X-ray sources in the inspection system's design so that the focal spots of the X-ray sources are located at the same height above the ground and at the same distance from the inspected object throughout the entire inspection process. Such positioning of the sources allows to combine different images geometrically for mathematical processing.

Yet another aspect of the invention is a method of combining the projections received from two different sources in accordance with the structure described above.

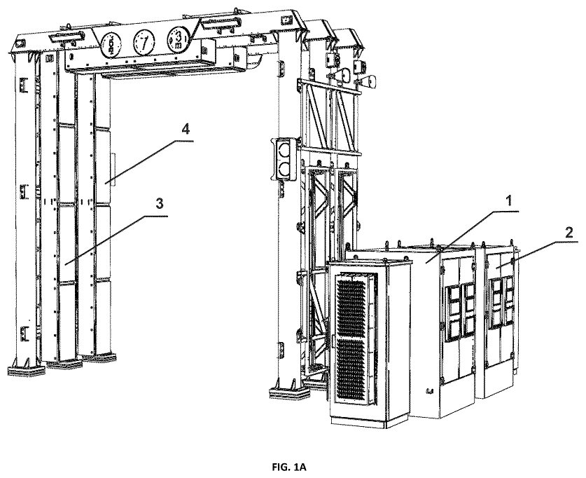

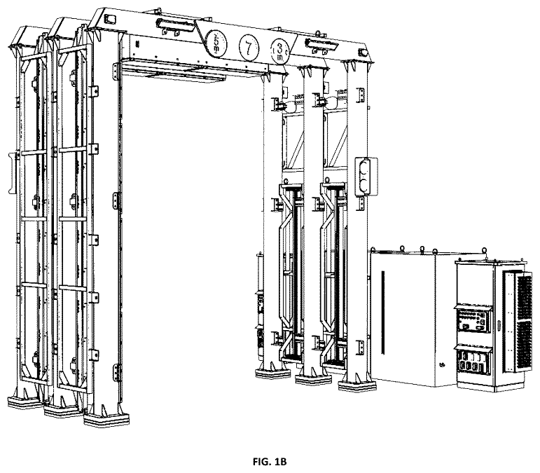

A sample use of the invention is in a vehicle and cargo inspection system (FIGS. 1A, 1B) in which an electron accelerator with an energy of 7.5/5 MeV (beams are emitted in short pulses alternating between 7.5 MeV and 5 MeV) is used as a high-energy source (FIG. 1A item 1), and an X-ray generator with an energy of 320 keV is used as a low-energy source (FIG. 1A item 2). Atomic numbers at high energies are calculated from the detected by the radiation receiver (FIG. 1A item 3) photons at 7.5 and 5 MeV energies. Conversely, in order to determine atomic numbers at low energies, a two-layer linear radiation receiver (FIG. 1A item 4) is used, in which scintillating layers are positioned one above the other, with a filter between them that defines the energies reaching each of the layers for atomic number calculation.

Information about atomic numbers that is used for material discrimination can be taken from dual-energy technology described below. This technology is widely used in x-ray inspection systems, but is limited for different applications. The system described herein extends possibilities of dual-energy technology.

As is well known, the intensity of X-ray radiation when passing through a substance is attenuated in accordance with the Lambert-Beer law:

$$I = {I}_{0} \cdot {e}^{- {μ}_{m} ρ \cdot d} \qquad ( 1 )$$

where I—detector signal after attenuation by a substance; I₀—detector signal without any substance; μm—mass absorption coefficient of a substance; ρ—volumetric density of a substance; d—substance thickness.

Dual-energy technology involves measuring detector signals I^{E1} and I^{E2} at two different levels of photon energy E1 and E2. The measured signals are converted in such a way as to obtain a quantitative measure that allows different materials to be distinguished:

$$f ( {Z}_{eff} , E 1 , E 2 ) = \frac{ln ( {I}^{E 1} / {I}_{0}^{E 1} )}{ln ( {I}^{E 2} / {I}_{0}^{E 2} )} = \frac{{μ}^{E 1}}{{μ}^{E 2}} \qquad ( 2 )$$

where μ^{E1} and μ^{E2}—mass coefficients of total attenuation of radiation by matter, which are known, for example, from [1].

The parameter f (Z_{eff}, E1, E2) after calibration at selected effective energies E1 and E2 is used to separate materials by effective atomic number Z_{eff}.

Low-energy systems use X-ray tubes as radiation sources which are limited in maximum achievable photon energy by several hundred keV (typically by 160-320 keV). In contrast, high-energy systems are based on accelerators which are able to go up to several MeV (typically 4-7.5 MeV).

Both low- and high-energy sources are polyenergetic, i.e. simultaneously emit photons of different energies, the number of which is different at different energies. The typical energy distribution of number of photons is called a spectrum. When source energies are indicated, they mean the maximum possible energy of photons in the spectrum.

However, the detector signal is determined not by the maximum energy, but by the effective energy of the beam, which is determined by both the original spectrum of the source and the method of detecting the radiation.

For example, let us compare two systems based on X-ray tube 320 keV (low-energy system) and accelerator 7.5/5.0 MeV (high-energy system).

Using the known μ^{E1} and μ^{E2}, we calculate the values of the parameter f (Z_{eff}, E1, E2) (see equation (2)), for example for nitrogen (Z=7) and iron (Z=26), for two sources, taking into account their effective energies (E1 and E2), and compare the results in Table 1.

TABLE 1
Material discriminative properties
of low- and high-energy systems.

| | f(Z) | | |
|---|---|---|---|
| Source | Nitrogen | Iron | Δf(Z) = \|f(Z1) − f(Z2)\| |
| Accelerator 7.5/5.0 | 1.16479 | 1.14588 | 0.01891 |
| MeV | | | |
| X-ray tube 320 keV | 1.09756 | 1.88776 | 0.7902 |

For the accelerator, the degree of difference between nitrogen and iron Δf (Z) turned out to be 42 times less than for the X-ray tube 320 keV. The quality of material discrimination with the X-ray tube 320 keV remains much better. Energy range for each specific application is based on the density variations of the application object of inspection and are selected in a way to deliver the best quality of atomic number calculation at different densities.

In general, for thin materials, the material signature acquired from dual-energy accelerator can often be too weak for accurate material discrimination results; for thick materials, there may not be good enough photon statistics for accurate material discrimination results. Therefore, there is a finite range of attenuations over which material discrimination can work appropriately.

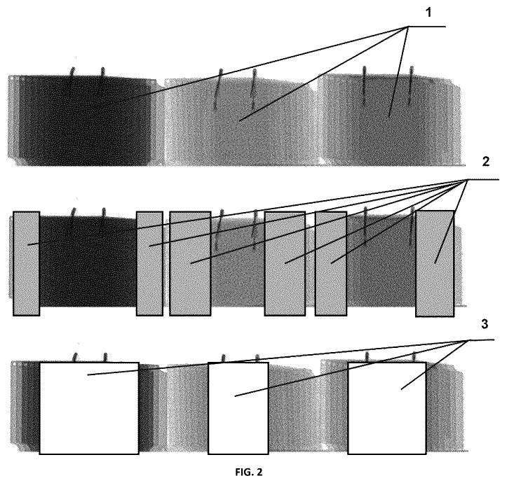

The higher energy systems based on the accelerator exhibit much higher penetration ability as can be seen at FIG. 2. Even in the dark spots, where low-energy systems are still able to get black-and-white image but cannot recognize type of materials, the accelerator-based system can get the image of acceptable quality.

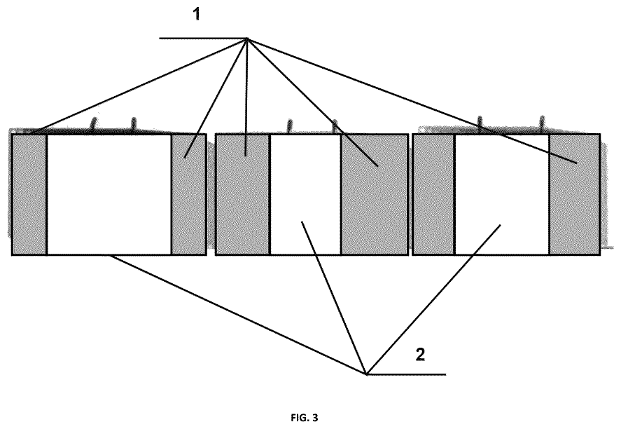

FIG. 2 shows penetration deficiency through a variable thickness object (FIG. 2 item 1) for 320 keV source (above) and high penetration combined with material identification for the accelerator. The invention, in one aspect, merges together the high material discrimination accuracy of low-energy system for thin materials (FIG. 2 item 2) and high penetration ability and material discrimination of high-energy system for thick materials (FIG. 1A item 3). According to our proposal, the object is scanned by 2 radiation sources at 4 different energy levels and all obtained images are fused by the dedicated algorithm. The result is illustrated in FIG. 3.

FIG. 3 illustrates multi-energy image fusion. As it can be seen from FIG. 3, the multi-energy image exhibits nice and confident material discrimination for objects which are widely varied in thickness from thin (FIG. 3 item 1) to thick (FIG. 3 item 2). No “black holes” now remain due to fusion material identification results from both projections.

### Spatial Resolution Advantages Provided by the Multi-Energy Technology

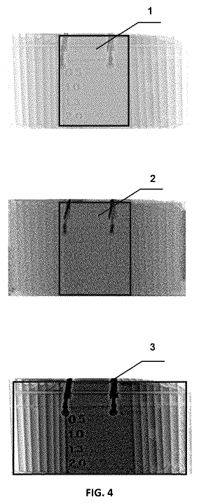

In some cases, the low-energy system cannot identify the material of a rather thick object but is still able to give more image details as compared to the accelerator-based system. The combination of both keeps the high image detail even in moderately thick parts of objects. As FIG. 4 shows, taken from low energy source (FIG. 4 item 1) and good material discrimination taken from high energy source (FIG. 4 item 2) the visibility of wires is kept in a fused (combined) image (FIG. 4 item 3). In FIG. 4, the multi-energy system keeps the highest image detail even on the thick background (see wires).

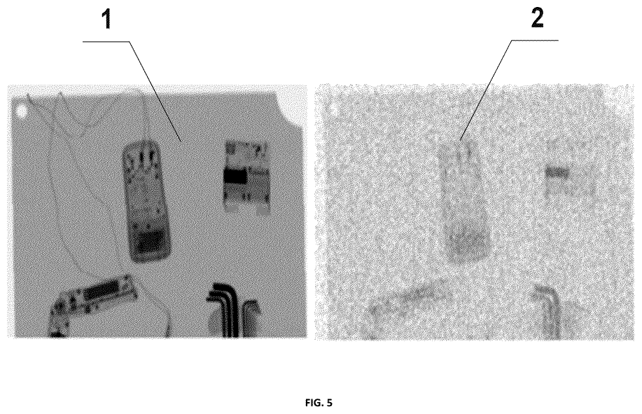

The present invention also includes the use of receivers with different resolutions which affects the spatial resolution of the resulting X-ray image. This makes it technically much easier to manufacture a receiver with higher resolution to register signals from a low-energy source. An exemplary comparison between a high-resolution image received from a low-energy source (FIG. 5 item 1) and an image received from a high-energy source (FIG. 5 item 2) is shown in FIG. 5, which shows samples of improved spatial resolution.

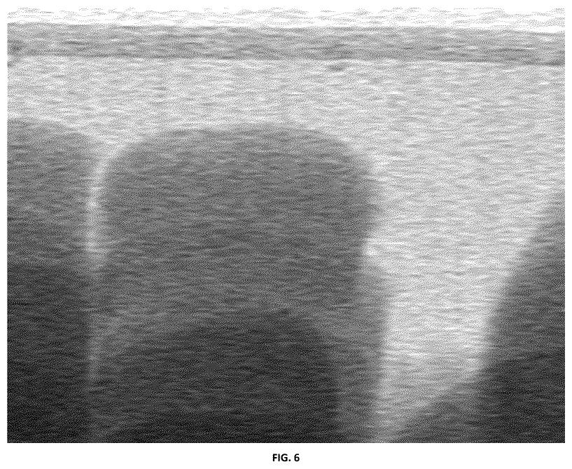

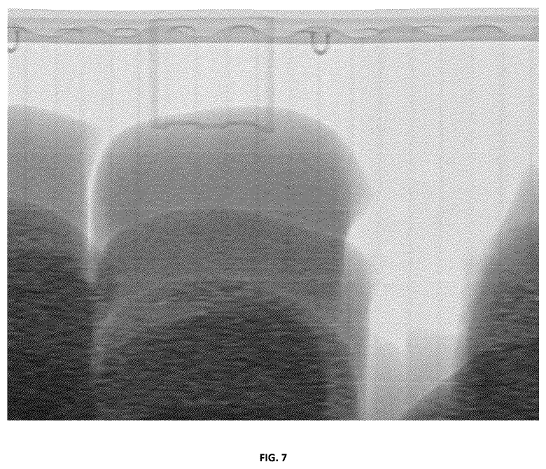

For example, a high-energy-only image is shown in FIG. 6, and a combined multi-energy image is shown in FIG. 7. It can be seen that some parts of the combined energy have retained low spatial resolution, and some parts, given sufficient penetrating power, have improved resolution.

### Description of Mutual Positioning of Sources and Receivers

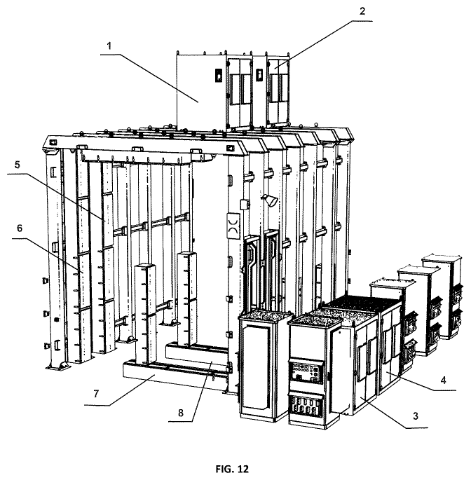

The structure of the system must ensure that the X-ray emitting points are at the same height above the ground and at the same distance from the object under scanning. At the same time, these points can be spaced along the axis of vehicle movement. The distance between them must be as short as possible in order to minimize the impact of non-uniform motion, especially vertical motion. Each source point shall emit fan-shaped X-ray beams that have to be on parallel planes. The object to be inspected must move as perpendicular as possible to the beam planes, and parallel to the line connecting the focal spots of the source points. Only in this way will it be possible to geometrically combine the projections of both sources into a single image. A number of additional X-ray sources arranged in parallel are also possible, e.g., positioned above, or at an angle relative to the vertical or relative to the direction of motion of the object being scanned. This significantly enhances the ability of the system to identify fine detail in the object being scanned. FIG. 12 shows another illustration of an exemplary system according to the invention with additional two X-Ray sources above the inspected vehicle/cargo and two U shaped receivers below the vehicle/cargo.

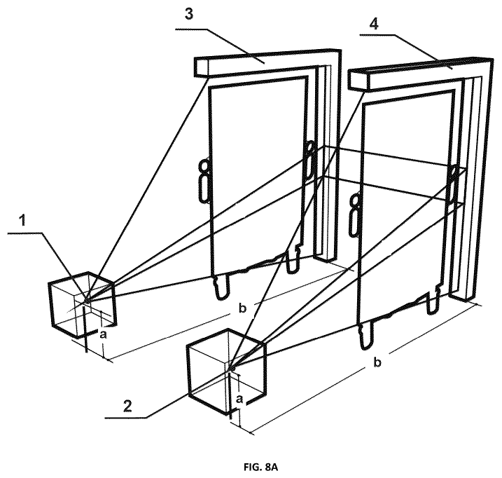

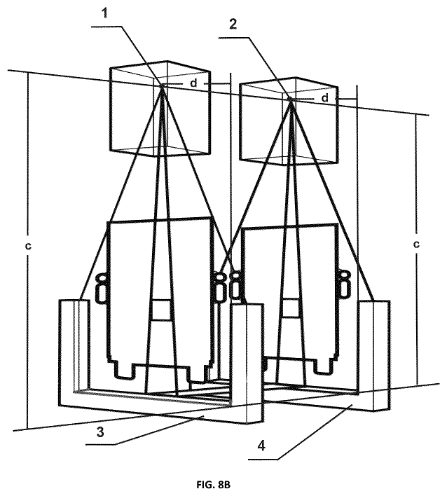

FIGS. 8A, 8B show a positioning scheme of the sources points relative to the inspected object from the side and from the top. FIG. 8A items 1 and 2 show high and low energy sources position for side inspection projection as well as FIG. 8A items 3 and 4 show radiation receiver positions for high and low energy sources radiation respectively. FIG. 8B items 1 and 2 show high and low energy sources position for top-bottom inspection projection as well as FIG. 8B items 3 and 4 show radiation receiver positions for high and low energy sources radiation respectively.

### Description of Mathematical Algorithms

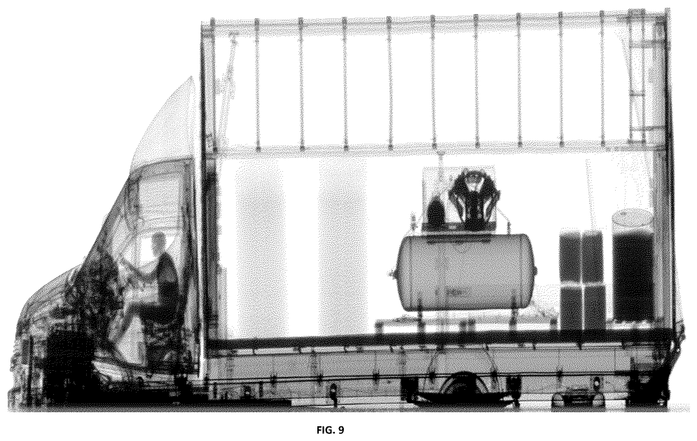

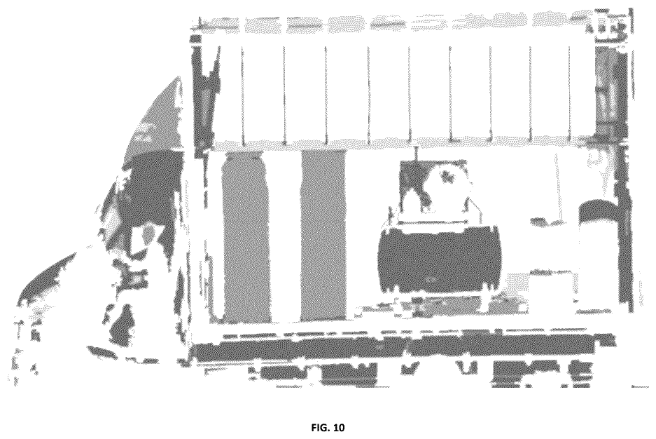

An important part of the invention is the mathematical processing algorithms for the images received from the high-energy source and the low-energy source. The acquisition of the images themselves and the calculation of atomic numbers on them are not part of the invention, but the subsequent combining of the images and their processing are. When the algorithms of the invention are to be applied, two 2D data matrices are already generated for each energy source. One matrix contains receiver's signal intensities for each point on the image of the inspected object, and the other matrix contains atomic numbers for each point on the image of the inspected object that have been calculated using the above algorithm. FIG. 9 shows a sample intensity matrix, where a different shade of gray represents different x-ray signal intensity at each point of the image and FIG. 10 shows a sample atomic number matrix, where different shades of gray represents different atomic numbers, that is used for material recognition.

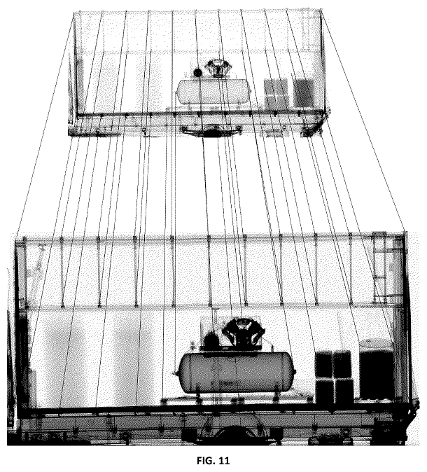

The first step in X-ray image processing is to combine the matrices of actual cargo coordinates from the high-energy and low-energy images, so that, when they are superimposed, the actual coordinates match, resulting in a single image. Such a superimposition is only possible thanks to the mutual positioning of the radiation sources and the object to be inspected. FIG. 11 thus illustrates an overlay of projection images made in 320 kV (on the bottom) and in 7.5 MeV (on the top). Connecting lines show some key points used as a reference for image transformations.

The second step is to analyze each point in the combined single image to select information to be used in the final single processed image. The selection is based on the following criteria:
1. the best atomic number discrimination of materials, and
2. the best penetration.

The third step is to generate the final X-ray image with the best parameters from both the high-energy source and the low-energy source and to store it for future review.

An exemplary application of the present invention is a vehicle and cargo inspection system that utilizes a cyclic electron accelerator with energy of 7.5/5 MeV (beams are emitted in short pulses alternating between 7.5 MeV and 5 MeV) and an X-ray generator with output voltage of 320 kV at the side of the vehicle and above it.

FIG. 12 shows another illustration of an exemplary system according to the invention. In this figure, 1—electron accelerator with high energy of 7.5/5 MeV (top-bottom projection); 2—X-ray generator with low energy of 320 keV (top-bottom projection); 3—electron accelerator with high energy of 6/4 MeV (side projection); 4—X-ray generator with low energy of 320 keV (side projection); 5—L-shape radiation receiver for 6/4 MeV energy, 6—L-shape radiation receiver for 320 kV energy; 7—U-shape radiation receiver for 7.5/5 MeV energy, 8—U-shape radiation receiver for 320 kV energy;

### Some Advantages of Using the Invention

1. A Single X-Ray Image (SXRI) can store information from two X-ray sources.
2. SXRI areas where the cargo density is low are generated based on the information received from a low-energy source. These areas have high quality atomic number discrimination at high resolution. Using high-energy emissions in these areas won't provide as good a level of discrimination as with low-energy emissions.
3. SXRI areas where the cargo density exceeds 60-70 mm in steel equivalent are generated based on the information received from a high-energy source. These areas also have decent atomic number discrimination, attained at the expense of resolution, however.
4. Since real-world cargoes consist of parts of varying densities, the methodology and structure underlying the present invention allow to attain a completely new level of image quality and even to modify it through mathematical processing and rendering. The present invention offers a unique multi-energy technology for vehicle and cargo inspection.
5. In contrast to systems based on linear electron accelerators, which are capable of providing high quality images, the system based on a cyclic accelerator exposes the object to be inspected to much smaller doses of radiation and allows the inspection of moving vehicles and, in some cases, even the driver's cabin with the driver inside. This allows for a tenfold increase in the speed of vehicle inspection while maintaining the image quality equal to or better than that of the linear accelerator in less dense areas of the cargo.
6. A cyclic accelerator supplemented by a 320 kV X-ray generator is significantly less expensive to purchase and maintain than a linear accelerator.
7. The use of 320 kV X-ray or similar generator, in combination with a linear accelerator, gives high resolution in the X-ray images of items that have both high and low density.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A system for scanning an object, comprising:
a first X-ray source emitting a first fan shaped X-ray beam;
a second X-ray source emitting a second fan shaped X-ray beam;
wherein the first and second fan shaped X-ray beams are parallel
a first detector and a second detector that detect X-rays passing through the object from the first and second X-Ray sources, respectively;
wherein the first X-ray source and the second X-ray source focal spots are at a same height;
wherein the object moves laterally past the first fan shaped X-ray beam and the second fan shaped X-ray beam and parallel to a line connecting focal spots of the first X-ray source and the second X-ray source;
wherein the first X-ray source is a source with a photon energy of E1 MeV and E2 MeV, such that beams are emitted in short pulses alternating between E1 and E2, wherein E1 and E2 are between 450 KeV and 9 MeV; and
wherein the second X-ray source is a source with a photon energy of E3, wherein E3 is between 70 KeV and 450 KeV; and
a workstation that combines atomic numbers and signal intensities obtained from the detector generated by X-rays from the first and second X-ray sources passing through the cargo.

2. The system of claim 1, wherein the object is any of a suitcases, a cargo, or a truck.

3. The system of claim 1, wherein the first and second detectors form an L-shape.

4. The system of claim 1, wherein photons of first source penetrate thick objects that are not penetrable by second x-ray source photons.

5. The system of claim 1, wherein photons of second source can penetrate only lower density objects that are too transparent for the photons of first X-Ray source.

6. The system of claim 1, wherein E1 is between 6 MeV to 7.5 MeV.

7. The system of claim 1, wherein E2 is between 3 MeV and 5 MeV.

8. The system of claim 1, wherein E3 is between 200 KeV and 450 KeV.

9. The system of claim 1, wherein the first and second X-ray sources are located on a side of a vehicle containing the object.

10. The system of claim 1, further comprising a third X-ray source emitting a third fan shaped X-ray beam; and
a fourth X-ray source emitting a fourth fan shaped X-ray beam;
wherein the third and fourth fan shaped X-ray beams are parallel to each other; and
a third detector and a fourth detector that detect X-rays passing through the object from the third and fourth X-Ray sources, respectively.

11. The system of claim 10, wherein the third X-ray source and the fourth X-ray source focal spots are at a same height and along the same horizontal line towards a motion axis of the object being scanned.

12. The system of claim 10, wherein the object moves laterally past the first fan shaped X-ray beam and the second fan shaped X-ray beam and parallel to a line connecting focal spots of the first X-ray source and the second X-ray source.

13. The system of claim 10, wherein the object moves laterally past the third fan shaped X-ray beam and the fourth fan shaped X-ray beam and parallel to a line connecting focal spots of the third X-ray source and the fourth X-ray source.

14. The system of claim 10, wherein the third X-ray source is a source with a photon energy of E1 MeV and E2 MeV, such that beams are emitted in short pulses alternating between E1 and E2, wherein E1 and E2 are between 450 KeV and 9 MeV; and
wherein the fourth X-ray source is a source with a photon energy of E3, wherein E3 is between 70 KeV and 450 KeV.

15. The system of claim 10, wherein the third and fourth detectors form a U-shape.

16. The system of claim 10, wherein photons of the first and third X-Ray sources penetrate thick objects that are not penetrable by second and fourth x-ray sources photons.

17. The system of claim 10, wherein photons of the second and fourth X-Ray sources can penetrate only lower density objects that are too transparent for the photons of the first and third X-Ray sources.

18. The system of claim 10, wherein the third and fourth X-ray sources are located over a top of a vehicle containing the object.
